(19) United States
(12) Patent Application Publication
(10) Pub. No.: US 2015/0270767 A1
(43) Pub. Date: Sep. 24, 2015

(54) MOVER AND LINEAR MOTOR EQUIPPED WITH THE MOVER

(71) Applicant: Hiroaki KUSAGA, Tokyo (JP)

(72) Inventor: Hiroaki Kusaga, Tokyo (JP)

(73) Assignee: Mitsubishi Electric Corporation, Tokyo (JP)

(21) Appl. No.: 14/443,431

(22) PCT Filed: Feb. 20, 2013
(86) PCT No.: PCT/JP2013/054201

§ 371 Date: May 18, 2015

(51) Int. Cl. H02K 41/02; H02K 1/06

(52) U.S. Cl. CPC H02K 41/02; H02K 1/06

(57) ABSTRACT

An object is to provide a mover that holds magnets and that achieves weight reduction and has reliability of strength. The present invention relates to the mover of a linear motor. The mover includes a plurality of the magnets, the magnets being arrayed along a first direction, and metal covers, the metal covers being provided on both sides of the magnets so as the magnets are interposed therebetween and thus held in place. A plurality of protrusions, the protrusions extending in a second direction that is perpendicular to the first direction and formed in the metal covers on a surface at a side of the magnets. The magnets are provided between the protrusions.

### FIELD

The present invention relates to a mover and a linear motor equipped with the mover.

### BACKGROUND

A motor called a moving-magnet linear motor, in which a plurality of magnets are held in a mover without a back yoke being provided to the mover, is in conventional use. For example, Patent Literature 1 discloses a mover that holds magnets that are fitted in holes formed in an aluminum block.

### CITATION LIST

### Patent Literature

Patent Literature 1: Japanese Patent Application Laid-open No. 2007-312501

### SUMMARY

### Technical Problem

However, according to the conventional technique described above, the weight of the mover tends to increase because of the use of the aluminum block. If the weight of the mover increases, there is a problem in that it is difficult to sufficiently take advantage of the mover's acceleration performance. Furthermore, in order to prevent deformation of the mover due to the attractive magnetic forces of the magnets, the mover is required to be of sufficient strength.

The present invention has been achieved in view of the above problems and an objective of the present invention is to provide a mover that holds magnets and that is designed to ensure weight reduction and to ensure it has a certain strength.

### Solution to Problem

In order to solve the problems mentioned above and achieve the objective, the present invention relates to a mover of a linear motor. The mover includes: a plurality of magnets, the magnets being provided along a first direction; and metal covers, provided on both sides of the magnets, between which the magnets are interposed and by which the magnets are held. A plurality of protrusions are provided, and the protrusions extend in a second direction that is perpendicular to the first direction and formed in the metal covers and on a surface regarded as a side of the magnets, and the magnets are provided between the protrusions.

### Advantageous Effects of Invention

The mover according to the present invention can hold magnets in place whilst achieving the effect of ensuring weight reduction and strength.

### BRIEF DESCRIPTION OF DRAWINGS

FIG. 1 is a perspective view illustrating a schematic configuration of a linear motor according to a first embodiment of the present invention.

FIG. 2 is an exploded perspective view of the linear motor.

FIG. 3 is an exploded perspective view of a mover.

FIG. 4 is a perspective view of metal covers.

FIG. 5 is a plan view of the metal covers.

FIG. 6 is a sectional view taken along a line A-A illustrated in FIG. 5.

FIG. 7 is an exploded perspective view of a mover according to a first modification.

FIG. 8 is an exploded perspective view of a mover according to a second modification.

### DESCRIPTION OF EMBODIMENTS

Exemplary embodiments of a mover and a linear motor equipped with the mover according to the present invention will be explained below in detail with reference to the accompanying drawings. The present invention is not limited to the embodiments.

### First embodiment

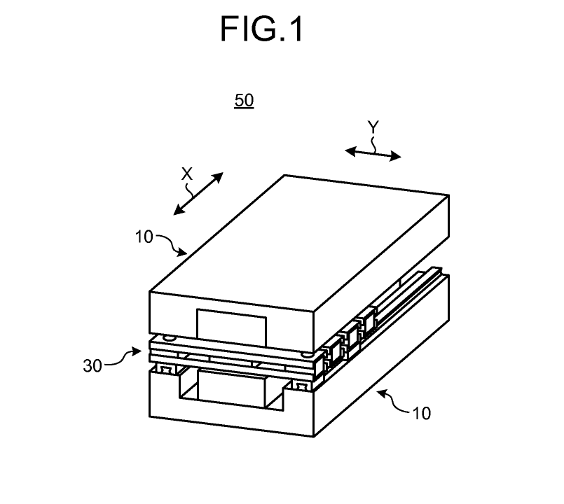

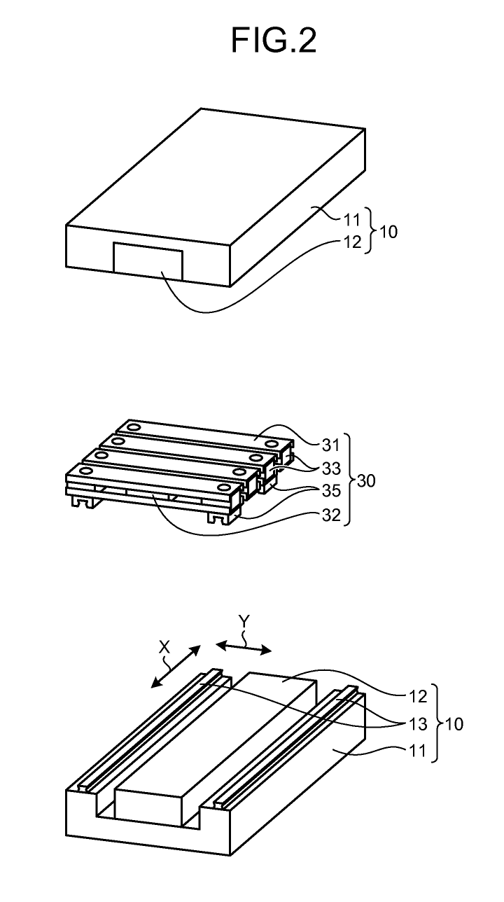

FIG. 1 is a perspective view illustrating a schematic configuration of a linear motor according to a first embodiment of the present invention. FIG. 2 is an exploded perspective view of the linear motor. A linear motor 50 includes stationary parts 10 and a mover 30. In the linear motor 50, the mover 30 provided between the stationary parts 10 is movable along a direction (first direction) indicated by an arrow X.

Each of the stationary parts 10 is configured by attaching a magnetic-field generating unit 12 and guide rails 13 to a stationary base 11. A pair of stationary bases 11 is provided between which the mover 30 interposes; and the magnetic-field generating unit 12 is attached to each of the stationary bases 11. Magnetic-field generating units 12 are provided such that they extend in the direction indicated by the arrow X. The magnetic-field generating units 12 are provided such that they face each other. The magnetic-field generating units 12 are, for example, armatures or back yokes, and they generate a magnetic field for moving the mover 30. Combinations are possible, for example, in which one of the magnetic-field generating units 12 is an armature and the other magnetic-field generating unit 12 is a back yoke or in which both of the magnetic-field generating units 12 are armatures. The guide rails 13 are provided on both sides of each of the magnetic-field generating units 12 and extend in the direction indicated by the arrow X.

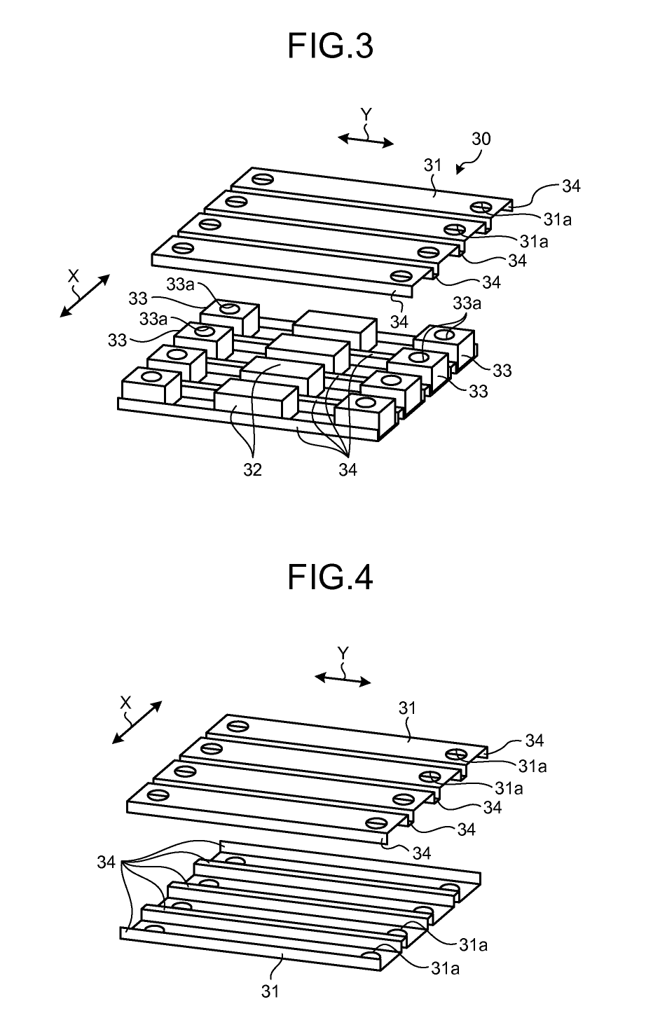

FIG. 3 is an exploded perspective view of the mover 30. The mover 30 includes metal covers 31, magnets 32, and reinforcing parts 33. The metal covers 31 are formed by folding thin metallic plates such as thin stainless-steel plates. In the mover 30, two metal covers 31 are provided and the magnets 32 and the reinforcing parts 33 are interposed and held therebetween.

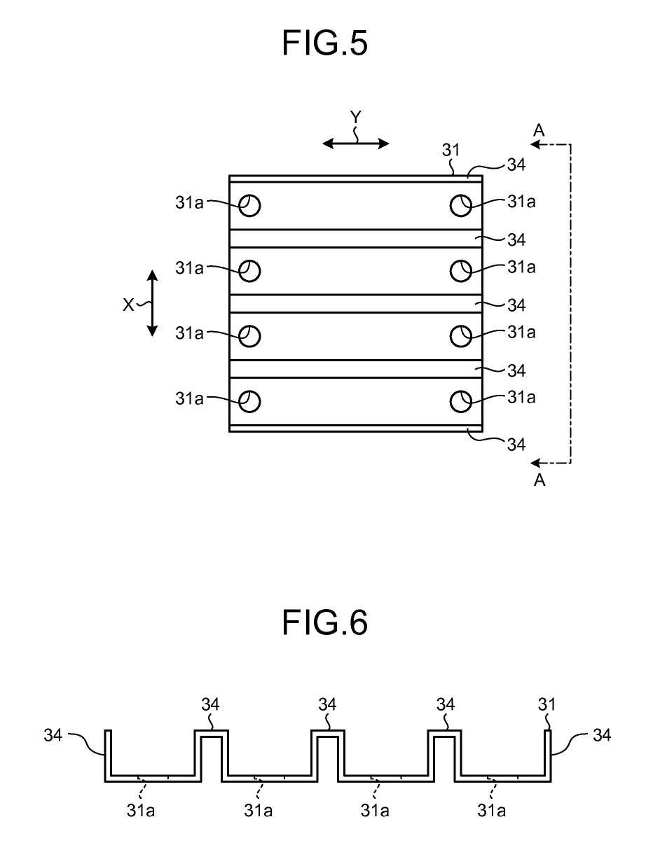

FIG. 4 is a perspective view of the metal covers 31. FIG. 5 is a plan view of the metal covers 31. FIG. 6 is a sectional view taken along a line A-A illustrated in FIG. 5. In each of the metal covers 31, one or more protrusions 34 are formed. The protrusions 34 extend in a direction (second direction) indicated by an arrow Y perpendicular to the direction indicated by the arrow X and are formed by means of folding the metallic thin plate.

A plurality of magnets 32 are fitted between the protrusions 34 that are adjacent to each other, respectively, so that the magnets 32 are arrayed along the direction indicated by the arrow X. The width between the protrusions 34 that are adjacent to each other and the width of each of the magnets 32 in the direction indicated by the arrow X are substantially equal and the magnets 32 are fitted between the protrusions 34 that are adjacent to each other, respectively, thereby preventing the displacements of the magnets 32 in the direction indicated by the arrow X.

The reinforcing parts 33 are formed of, for example, a resin material and are provided on both sides of each of the magnets 32. Through hole 33a and through hole 31a are formed in the reinforcing part 33 and the metal covers 31, respectively. The reinforcing parts 33 are provided at positions where the through holes 33a and the through holes 31a overlap with each other. By using the through holes 33a and 31a, mounting seats can be provided on the mover 30 for mounting the linear guides 35 onto the mover 30, or the linear guides 35 can be directly attached to the mover 30.

The linear guides 35 attached with the use of the through holes 33a and 31a and the guide rails 13 provided on the stationary parts 10 engage with each other so that the mover 30 is guided along the guide rails 13 so as to be movable in the direction indicated by the arrow X.

The reinforcing parts 33 are formed to have substantially the same height as that of the magnets 32 and function as reinforcing members that prevent the metal covers 31 from being crushed at portions where the magnets 32 are not present. In the present embodiment, the reinforcing parts 33 are provided between the adjacent protrusions 34 of the metal covers 31 and at both ends thereof in the direction indicated by the arrow Y. Gaps are provided between the magnets 32 and the reinforcing parts 33. In a case where the reinforcing parts 33 are provided near the through holes 31a so that a certain space is formed between the magnets 32 and the reinforcing parts 33, as illustrated in FIG. 4, the weight can be further reduced as compared to a mover configured by fitting magnets in an aluminum block even when a material having a larger specific gravity than that of aluminum is used as the reinforcing parts 33. Instead of using the reinforcing parts 33 made of resin, nuts or washers made of, for example, metal (such as iron) can be used. The magnets 32 and the reinforcing parts 33 are fixed to the metal covers 31, thereby suppressing displacement in the direction indicated by the arrow Y. The magnets 32 and the reinforcing parts 33 are adhered to the metal covers 31, for example, with an adhesive.

In accordance with the mover 30 described above, the magnets 32 are interposed between and held by the metal covers 31, which are formed from a thin plate. Therefore, the weight of the mover 30 can be reduced when compared to a case where the magnets 32 are fitted and held in a metallic block.

Reduction in the weight of the mover 30 enables easier enhancement of the acceleration rate of the mover 30. Because gaps are formed between the magnets 32 and the reinforcing parts 33, the weight can be reduced by as much as the gaps. Furthermore, by forming the reinforcing parts 33 of a resin material, further reduction in the weight can be brought.

Because the width of the magnets 32 in the direction indicated by the arrow X and the width between the protrusions 34 that are adjacent are substantially equal and the magnets 32 are fitted into between the protrusions 34 that are adjacent, displacement of the magnets 32, due to acceleration or deceleration during movement of the mover 30, can be reduced in the direction indicated by the arrow X.

Because the metal covers 31 are formed by folding a metallic thin plate, the working thereof is easy and the manufacturing cost can be reduced. Furthermore, when compared to the case where the magnets 32 are held using a metallic block, the amount of material used can be reduced and the manufacturing cost can be further reduced.

When the linear guides 35 are attached directly to the mover 30 by using the through holes 31a and 33a, mounting seats for mounting the linear guides 35 thereon are not required and thus the structure of the mover 30 can simplified and its weight can be reduced.

Folding to form the protrusions 34 can increase the strength of the metal covers 31. Accordingly, even when the metal covers 31 are formed from a thin plate, sufficient strength can be easily ensured. In the linear motor 50, a force to deform the mover 30 may be applied thereto because the magnets 32 are pulled due to magnetic forces. Therefore, by increasing the strength of the metal covers 31, deformation of the mover 30 can be ensured.

It becomes difficult for the mover 30 to deform such that it becomes uneven when viewed from the direction indicated by the arrow Y because the mover 30 is held and restricted by the guide rails 13 that extend in the direction indicated by the arrow X and that hold the mover 30. Furthermore, deformation of the mover such that it becomes uneven when viewed from the direction indicated by the arrow X tends to occur. In the present embodiment, the protrusions 34 are thus provided to extend in the direction indicated by the arrow Y, thereby making the occurrence of uneven deformation when viewed from the direction indicated by the arrow X more difficult.

The protrusions 34 formed on the metal covers 31 are not limited to those formed by folding a thin plate. For example, it is also possible to project projection formed on the thin plate. The width of the magnets 32 in the direction indicated by the arrow X can be formed to be smaller than the width between the protrusions 34 that are adjacent to each other. Although the magnets 32 are not tightly fitted between the protrusions 34 that are adjacent to each other, the effect of reducing the displacement of the magnets 32 is still expected in the direction indicated by the arrow X by fixing the magnets 32 to the metal covers 31 with an adhesive or the like.

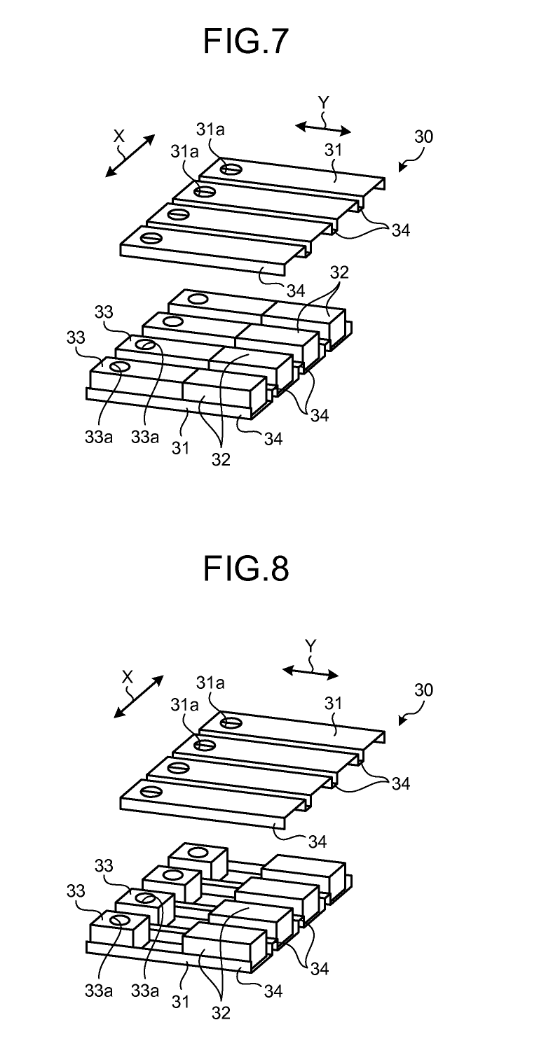

FIG. 7 is an exploded perspective view of the mover 30 according to a first modification. In the first modification, the reinforcing parts 33 are provided only on one side of the magnets 32. Accordingly, reduction in the weight of the mover 30 can be achieved by a smaller number of the reinforcing parts 33 than in a case where the reinforcing parts 33 are provided on both sides of the magnets 32.

The magnets 32 and the reinforcing parts 33 are provided to be in contact with each other. The total length of the magnet 32 and the reinforcing part 33 is substantially equal to the width of the metal covers 31 in the direction indicated by the arrow Y. This facilitates positioning when the magnets 32 and the reinforcing parts 33 are provided on the metal covers 31. Even in a case where most of the area except for the magnets is occupied by the reinforcing parts 33 as illustrated in FIG. 7, further reduction in the weight when compared to the mover configured by fitting the magnets in an aluminum block can be achieved by the use of a material having a lower specific gravity than that of aluminum as the reinforcing parts 33.

For example, by providing the reinforcing parts 33 so as to align one end thereof with one end of the metal covers 31 and then providing the magnets 32 so as to be in contact with the reinforcing parts 33, the magnets 32 and the reinforcing parts 33 can be positioned. Accordingly, it is unnecessary to make marks or uneven portions for positioning on the metal covers 31, the magnets 32, nor the reinforcing parts 33. The same holds true for a case where the reinforcing parts 33 are provided on both sides of the magnets 32, as illustrated in FIG. 3, and by providing the magnets 32 so as to be in contact with the reinforcing parts 33, the magnets 32 and the reinforcing parts 33 can be easily positioned.

FIG. 8 is an exploded perspective view of the mover 30 according to a second modification. In the second modification, the reinforcing parts 33 are provided only on one side of the respective magnets 32, which is similar to the first modification. Accordingly, reduction in the weight of the mover 30 can be achieved by having a smaller number of the reinforcing parts 33 than in a case where the reinforcing parts 33 are provided on both sides of the magnets 32. Furthermore, by providing gaps between the magnets 32 and the reinforcing parts 33, the weight can be reduced by the part that would be occupied by the gaps.

### INDUSTRIAL APPLICABILITY

As described above, the mover according to the present invention is useful in a mover that includes magnets.

### REFERENCE SIGNS LIST

10 stationary part, 11 stationary base, 12 magnetic-field generating unit, 13 guide rail, 30 mover, metal cover, 31a through hole, 32 magnet, 33 reinforcing part, 33a through hole, 34 protrusion, 35 linear guide, 50 linear motor.

1. A mover provided between magnetic-field generating units facing each other in a linear motor, the mover comprising:
a plurality of magnets, the magnets being provided along a first direction; and
metal covers, provided on both sides of the magnets, between which the magnets are interposed and by which the magnets are held, the both sides being regarded as sides of the magnetic-field generating units with respect to the magnets, wherein
a plurality of protrusions, the protrusions extending in a second direction that is perpendicular to the first direction and formed in the metal covers and on a surface regarded as a side of the magnets, and
the magnets are provided between the protrusions.

2. The mover according to claim 1, wherein
the magnets are fitted between the protrusions.

3. The mover according to claim 1, wherein
the metal covers having the protrusions formed thereon are formed by folding a metallic thin plate.

4. The mover according to claim 1, further comprising reinforcing parts that
are provided on at least one side of the magnets,
are along the second direction, and
are interposed between the metal covers.

5. The mover according to claim 4, wherein
gaps are provided between the magnets and the reinforcing parts.

6. The mover according to claim 4, wherein
the magnets and the reinforcing parts are provided so as to be in contact with each other.

7. The mover according to claim 4, wherein
through holes that penetrate the metal covers and the reinforcing parts are formed.

8. The mover according to claim 4, wherein
the reinforcing parts are made of resin.

9. A linear motor comprising:
the mover according to claim 1; and
stators moving the mover in the first direction, wherein
the stators are provided with guide rails extending in the first direction and with a back yoke extending in the first direction, and
the mover is provided with linear guides that are in contact with the guide rails and enable the mover to move along the guide rails.
